(19) United States
(12) Patent Application Publication
(10) Pub. No.: US 2025/0108901 A1
(43) Pub. Date: Apr. 3, 2025

(54) FLOATING POWER GENERATION

(71) Applicant: Saudi Arabian Oil Company, Dhahran (SA)

(72) Inventors: Mustafa Karakaya, Dhahran (SA); Sohrat Baki, Dhahran (SA); Emre Cenker, Dhahran (SA); Coruh Celikbilek, Dhahran (SA)

(21) Appl. No.: 18/479,463

(22) Filed: Oct. 2, 2023

(51) Int. Cl. B63H 21/00; B63B 35/44; H01M 8/22

(52) U.S. Cl. CPC B63H 21/00; B63B 35/44; H01M 8/22; B63B 2035/4433; B63H 2021/003

(57) ABSTRACT

A floating power generation system includes a marine vessel, an energy conversion system mounted on the marine vessel, and a fuel storage system mounted on the marine vessel. The energy conversion system includes a hydrogen fuel cell, and the fuel storage system is fluidly connected to the energy conversion system. The fuel storage system supplies hydrogen fuel to the hydrogen fuel cell of the energy conversion system.

### TECHNICAL FIELD

This disclosure relates to floating power generation ships.

### BACKGROUND

Some regions of the world lack access to reliable electricity or lack adequate infrastructure for conventional electricity generation and distribution, such as from land-based power plants. Powerships can be utilized to provide electricity to meet demand in these regions. A powership is a special purpose ship that includes a power plant installed to serve as a source of power generation, and is converted from an existing ship, like a cargo ship. A powership is a floating vessel that is mobile over water and can be self-propelled. A power barge is an unmotorized powership, where a power plant is installed on a deck barge that can be moved by a separate transportation source. A powership can provide temporary or permanent infrastructure for power generation, such as for developing regions of the world that plug into national grids, and can be used for disaster relief efforts, or serve as floating power plants for offshore oil and gas platforms.

### SUMMARY

This disclosure describes floating power generation systems, such as powerships and power barges, including an energy conversion system that uses hydrogen as fuel.

In some aspects, a floating power generation system includes a marine vessel, an energy conversion system mounted on the marine vessel, and a fuel storage system mounted on the marine vessel. The energy conversion system includes a hydrogen fuel cell, and the fuel storage system is fluidly connected to the energy conversion system to supply hydrogen fuel to the hydrogen fuel cell of the energy conversion system.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic side view of an example floating power generation system including a marine vessel with an energy conversion system.

FIG. 2 is a schematic top view of the example floating power generation system of FIG. 1.

FIG. 3 is a schematic top view of a second example floating power generation system including the marine vessel of FIG. 1.

FIG. 4 is a schematic side view of a third example floating power generation system including the marine vessel of FIG. 1 and a second marine vessel.

FIG. 5 is a schematic side view of an example fuel supply system that can be used in the second example floating power generation system of FIG. 4.

FIG. 6 is a schematic side view of a fourth example floating power generation system including the marine vessel of FIG. 1 and the example fuel supply system of FIG. 5.

FIG. 7 is a flowchart describing an example method for generating power on a marine vessel.

Like reference numbers and designations in the various drawings indicate like elements.

### DETAILED DESCRIPTION

This disclosure describes floating power generation systems, such as powerships, for generating electrical power. A floating power generation system includes a marine vessel that supports an energy conversion system with one or more hydrogen fuel cells for generating an amount of electrical power from a hydrogen fuel. In the present disclosure, an energy conversion system with one or more hydrogen fuel cells generates electrical output using gaseous hydrogen as fuel, which, for example, produces little to no greenhouse gas emissions when the hydrogen fuel is consumed in the fuel cells. The floating power generation system can include a self-propelled powership or un-motorized powership (for example, a power barge) that is fitted with an energy conversion system for generating electrical power, and a fuel storage system for storing and supplying fuel to the energy conversion system. The floating power generation system includes an energy transformation system fixedly attached or otherwise mounted on the powership and connected to the energy conversion system. The energy transformation system receives the produced electrical power from the energy conversion system and stores the produced energy, directs the produced energy to a destination, or both. In some implementations, such as instances of the energy conversion system including one or more hydrogen fuel cells, the floating power generation system includes a water processing system fixedly attached or otherwise mounted on the powership and fluidly connected to the hydrogen fuel cell(s) of the energy conversion system. The water processing system receives water byproduct from the hydrogen fuel cell(s) of the energy conversion system, and stores the water in a water storage tank, directs the water to other destinations within the powership, directs the water to a remote destination over a floating or suspended pipe network, or a combination of these. The powership can also include a command module to control operation of the energy conversion system, fuel storage system, energy transformation system, water processing system, a combination of these, or other operational components of the powership.

Powerships can transport over water and anchor, dock, or otherwise reside at a desired destination, such as near a coast of a region in need of electrical power or near an offshore oil and gas platform. Due to their mobility, powerships can connect to a local power grid via a floating or suspended electrical cable system extending between the powership and an access point to the local power grid, for example, to provide electrical power that partially or completely covers electrical demand on the power grid. For example, a powership can provide electrical power to a local power grid in instances where on-site power plants are insufficient, non-operational, under construction, or otherwise unable to provide sufficient power to a grid on its own. A powership can interact with available infrastructure at the destination. In conventional powerships, mixed fuel engines on board are powered by liquid fuels, such as liquid hydrocarbon-based fuel, natural gas, or a combination of these. Power generation using fossil fuel-based generators have adverse effects on the environment, and contribute to greenhouse gas emissions and climate change. In the floating power generation systems of the present disclosure, a marine vessel (for example, powership) includes an energy conversion system that uses clean gaseous hydrogen (H₂) as fuel, which can reduce or avoid the generation of greenhouse gases while still generating electrical energy via hydrogen fuel cells or hydrogen combustion engines. Hydrogen is a versatile fuel that can be produced through varying methods, including electrolysis of water using renewable energy sources. The energy conversion system on the marine vessel includes one or more energy conversion units, such as hydrogen internal combustion engines, hydrogen gas turbines, hydrogen fuel cells, or a combination of these, which convert a supplied amount of hydrogen fuel into a produced amount of electrical power. These energy conversion units are highly efficient, enabling the energy conversion system to generate electricity on board the marine vessel with minimal energy loss and high reliability. In some implementations, a hydrogen fuel cell(s) or engine(s) are integrated into the marine vessel's propulsion system, enabling the marine vessel to operate as a self-contained, self-supporting, and mobile power generation system. The type and amount of energy conversion units of the energy conversion system on the marine vessel can be selected based on a desired power output, cost requirements, or other factors.

Hydrogen fuel cells, hydrogen combustion engines, or other hydrogen-based generators create water as a byproduct from the conversion of hydrogen to electricity. In some implementations, a floating power generation system includes a water processing system that captures the water byproduct and processes and purifies it to be suitable for other applications. For example, the water can be utilized, on the marine vessel or elsewhere, for drinking, cooling systems, irrigation, a combination of these, or other industrial applications. The freshwater byproduct can be transported to an onshore location through a flexible pipeline(s), utilized or stored onboard the marine vessel, or both. The storage and use of this water minimizes waste and maximizes an overall efficiency of the floating power generation system. For example, the floating power generation system of the present disclosure offers a mobile and sustainable solution for supplying electricity, water, or both, to areas in need of electricity, fresh water, or both, by utilizing hydrogen as a fuel source and utilizing the byproduct water, thereby providing environmental benefits by reducing carbon emissions and promoting efficient resource management.

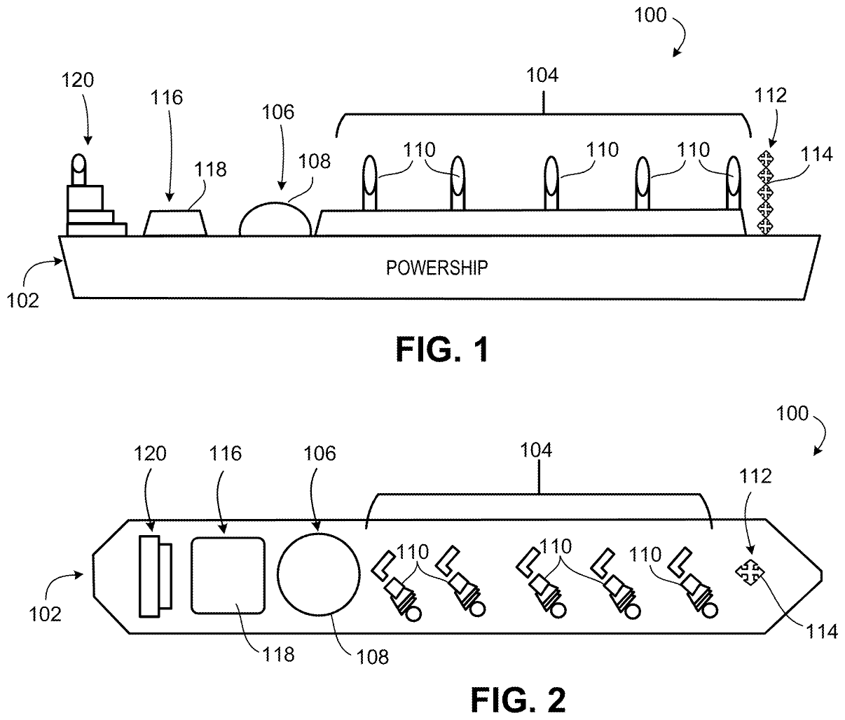

FIG. 1 is a schematic side view of an example floating power generation system 100 including a marine vessel 102. FIG. 2 is a schematic top view of the example floating power generation system 100 of FIG. 1. Referring to FIGS. 1 and 2, the marine vessel 102 of the example floating power generation system 100 is fitted with an energy conversion system 104 mounted on a deck of the marine vessel 102, and a fuel storage system 106 mounted on the deck of the marine vessel 102 and fluidly connected to the energy conversion system 104 to supply hydrogen fuel to the energy conversion system 104. The fuel storage system 106 includes a fuel storage tank 108 and a fuel supply line (not shown) fluidly connected to the energy conversion system 104, for example, for storing gaseous hydrogen and directing some or all of the gaseous hydrogen in the fuel tank to the energy conversion system 104. In operation, the energy conversion system 104 generates electrical power from the hydrogen fuel supplied by the fuel storage system 106. The energy conversion system 104 of the example floating power generation system 100 includes multiple energy conversion units 110 (five shown) that can operate separately or together to generate an amount of electrical power from an amount of supplied hydrogen fuel from the fuel storage system 106. In the example, floating power generation system 100 of FIGS. 102, the energy conversion units 110 are fuel cells that use hydrogen gas as a fuel source for generating electricity. The fuel cells can include proton exchange membrane (PEM) fuel cells, solid oxide fuel cells (SOFCs), a combination of these, or another type of fuel cell that uses hydrogen as fuel. Hydrogen fuel cells use the chemical energy of the hydrogen gas to produce electricity, and have a higher operating efficiency and fewer pollutant emissions, for example, compared to thermodynamic engines that produce nitrogen oxides (NOx), an undesirable greenhouse gas. Also, condensing fresh water from fuel cells is easier and less energy demanding as compared to thermodynamic engines because the operating temperature of fuel cells, and thus the temperature of its water byproduct, is significantly less than the temperature of thermodynamic energy conversion units. Even further, fuel cells have lower maintenance costs, and associated hazards with fuel cells are lower, for example, as compared to combustion energy converters.

All or a portion of the fuel cells of the energy conversion system 104 can operate separately or at the same time, for example, based on a desired electrical energy output. In some examples, the floating power generation system 100 operates to produce a minimum threshold energy output from the energy conversion system 104, and the amount of hydrogen fuel, the number of energy conversion units 110 in operation, or both, are controlled to produce an amount of produced energy that is equal to or greater than the minimum threshold energy output.

Although the energy conversion system 104 of the example floating power generation system 100 includes five fuel cells, the type of energy conversion unit 110 can vary. In some implementations, one or more or all of the energy conversion units 110 include an internal combustion engine or a gas turbine, in addition to or instead of a fuel cell, to efficiently generate electrical energy from a supplied amount of hydrogen fuel. In certain implementations, the energy conversion system 104 includes fewer or more energy conversion units 110, such as one, two, four, six, or more energy conversion units 110. The energy capacity of the example floating power generation system 100 can vary based on the operation and number of the energy conversion units 110, and ever the volume of hydrogen fuel that can be supplied by the fuel storage system 106. In some examples, the marine vessel 102 of the example floating power generation system 100 has a power capacity between 5 megawatts (MW) and 2,000 MW. In certain implementations, the example floating power generation system 100 can include more than one marine vessel 102 (and associated power generating components) to provide a desired power capacity at a specified destination that is greater than a power capacity of a single marine vessel 102. For example, the marine vessel 102 can be scaled and adapted to varying energy demands, and multiple marine vessels 102 can be deployed and interconnected to create larger power networks to meet growing energy needs of an expanding community or industrial complex.

In the example floating power generation system 100 of FIGS. 1 and 2, the energy conversion system 104 spans a majority of the deck of the marine vessel 102. For example, the energy conversion units 110 are positioned along the deck of the marine vessel 102 along a length of the deck that is greater than half of the total length of the deck of the marine vessel. The footprint of the deck of the marine vessel 102 of the example floating power generation system 100 is dedicated mostly to the energy conversion system 104, for example, to maximize a ratio of energy output from the example floating power generation system 100 to the footprint of the marine vessel 102. In some examples, the energy conversion system 104 covers a majority of the deck of the marine vessel 102, such as about 60%, 70%, 75% or more of the deck. However, the positioning and distribution of the energy conversion units 110 can vary from the schematic positioning shown over the example marine vessel 102 of FIGS. 1 and 2. For example, the energy conversion system 104 can span less than half of the total length of the deck of the marine vessel 102.

The example floating power generation system 100 also includes an energy transformation system 112 mounted on the marine vessel 102 and electrically connected to the energy conversion system 104 to receive the produced energy from the energy conversion system 104. The energy transformation system 112 receives the produced electrical power from the energy conversion system 104 and directs the produced electrical power to a desired location. For example, the energy transformation system 112 of the example floating power generation system 100 includes a tower structure 114 for connecting to and suspending a cable system (not shown) for distributing the produced electrical energy to a desired location. This cable system and tower 114 is described in greater detail later. In some instances, the energy transformation system 112 also includes transformers, regulators, metering, switching, protection devices, a combination of these, or other regulating equipment for controlling and directing the received electrical power, regulating a frequency of the electrical energy from the energy transformation system 112 to a destination, safeguarding the load and generator side circuits, or a combination of these. For example, each energy conversion unit 110 can be equipped with a respective energy transformation system, including a voltage step-up transformer, to step-up or step-down the generated power to voltage levels corresponding to a load(s) being supplied at the desired destination. The energy transformation system 112 includes one or more DC to AC inverters connected to the energy conversion units 110, such as fuel cells. In some implementations, the marine vessel 102 of the example floating power generation system 100 excludes batteries or other power storage devices, although batteries or other storage devices can be supplied power from the energy transformation system 112 in instances where the energy transformation system 112 is electrically connected to the batteries or other storage devices.

Energy conversion units 110 that utilize hydrogen as fuel to generate electrical power also generate water as a byproduct, such as through reverse electrolysis using a hydrogen fuel cell. In some implementations, the example floating power generation system 100 includes a water processing system 116 mounted on the marine vessel 102 and fluidly connected to the energy conversion system 104 (for example, hydrogen fuel cell(s) of the energy conversion system 104) to receive the water byproduct from generating electricity using gaseous hydrogen fuel. The water processing system 116 includes a water storage tank 118 for receiving and storing the water byproduct. The water storage tank 118 can also be used to distribute the water to a desired location within the marine vessel 102 or to a different destination remote from the marine vessel 102. In some examples, the stored water can be used as a potable water supply for the marine vessel 102, irrigation within the marine vessel 102, or as a coolant for operational systems on the marine vessel 102.

The water processing system 116 captures and recovers water vapor from the exhaust stream of the energy conversion unit(s) 110. The water processing system 116 is adaptable to various combustion and electrochemical processes, including those in power plants, industrial facilities, fuel cells, internal combustion engines, a combination of these, or other processes. The water processing system 116 leverages advanced technologies to efficiently and effectively recover water vapor, which can provide benefits including resource utilization and reduction in environmental impacts.

In some instances, the water processing system 116 includes an exhaust inlet (not shown) to receive all or a portion of the exhaust stream from the energy conversion system 104. The exhaust inlet can include one or more filters, flow control devices, or both, to regulate the flow of the exhaust stream and remove particulate matter, improving the quality of the captured water. The water processing system 116 can also include a cooling and condensation unit (not shown) to cool the exhaust gases using heat exchange technology. The process of cooling the exhaust gases reduces the temperature of the exhaust gases, thereby causing the water vapor in the exhaust stream to condense into liquid water. The condensed water droplets are then collected in a reservoir, such as the water storage tank 118. The collected liquid water is stored in the water storage tank 118. The storage tank 118 can include a drainage system to promote the efficient removal of recovered water from the exhaust stream, for example, to prevent or reduce any overflow or flooding. The water storage tank 118 can be connected to a water utility network of the marine vessel 102.

In some implementations, the water processing system 116 includes a monitoring system including sensors and controls for monitoring the purity of the recovered water, and if desired based on the monitored purity or data from the sensors, activate a purification process to purify the recovered water.

The marine vessel 102 of the example floating power generation system 100 is a powership with a cargo deck supporting one or more or all of the energy generation system 104, fuel storage system 106, energy transformation system 112, and water processing system 116 of the powership. In some instances, the powership includes a command module 120 for controlling operation of the marine vessel 102, or powership. For example, the command module 120 can control operation of the energy conversion system 104, fuel storage system 106, energy transformation system 112, water processing system 116, a combination of these components, or other operational components of the marine vessel 102. For example, in instances where the powership is self-propelled, the command module 120 can also control a propulsion system of the marine vessel.

The marine vessel 102 of the example floating power generation system 100 can operate as a self-contained, self-supporting, and mobile power generator that utilizes a clean energy source of hydrogen fuel and generating water as a byproduct. For example, the example floating power generation system 100 provides a self-sufficient and independent power supply that is not reliant on external fuel availability or vulnerable to grid failures, providing a reliable and continuous source of electricity. Also, the example floating power generation system 100 uses hydrogen fuel to generate electricity, resulting in zero or near-zero greenhouse gas emissions. The example floating power generation system 100 provides a clean and sustainable alternative to conventional power generation methods by reducing carbon emissions and other pollutants, and contributing to global efforts to combat climate change. In some instances, such as in the case of a major disaster such as earthquakes, tsunamis, severe rain, storms, or other unexpected situation where an electric generation infrastructure is damaged or water utility infrastructure is damaged, the example floating power generation system 100 can traverse waterways and arrive at or near the destination to provide electrical power, a backup water supply, or both, to infrastructure at the destination. The mobility and versatility of the marine vessel 102 of the example floating power generation system 100 allows for the supplying of electricity to remote areas, including coastal regions, islands, and underserved communities, and can navigate waterways and reach locations normally inaccessible by other power grid infrastructure, thereby bringing reliable electricity to previously isolated areas. The example floating power generation system 100 can provide economic opportunities by enabling economic development in remote areas that would otherwise have less reliable access to electricity, thereby stimulating local businesses, supporting infrastructure development, and improving an overall quality of life for communities that may have previously lacked dependable power sources.

Hydrogen is an abundant element, and hydrogen gas can be derived from various renewable sources, such as water electrolysis powered by renewable energy sources like solar or wind. This abundance and derivation provides a long-term and sustainable fuel supply for the example floating power generation system 100. In some instances, solar panels can be used to generate electrical power, but transferring the electrical power over a long distance can be inefficient. In some implementations, produced electricity from solar panels, such as at a desert location, can be used to separate hydrogen to create blue hydrogen, which can be safely transferred over a long distance or be stored in an underground reservoir. The example floating power generation system 100 can travel to access this blue hydrogen and use it as fuel to generate electricity.

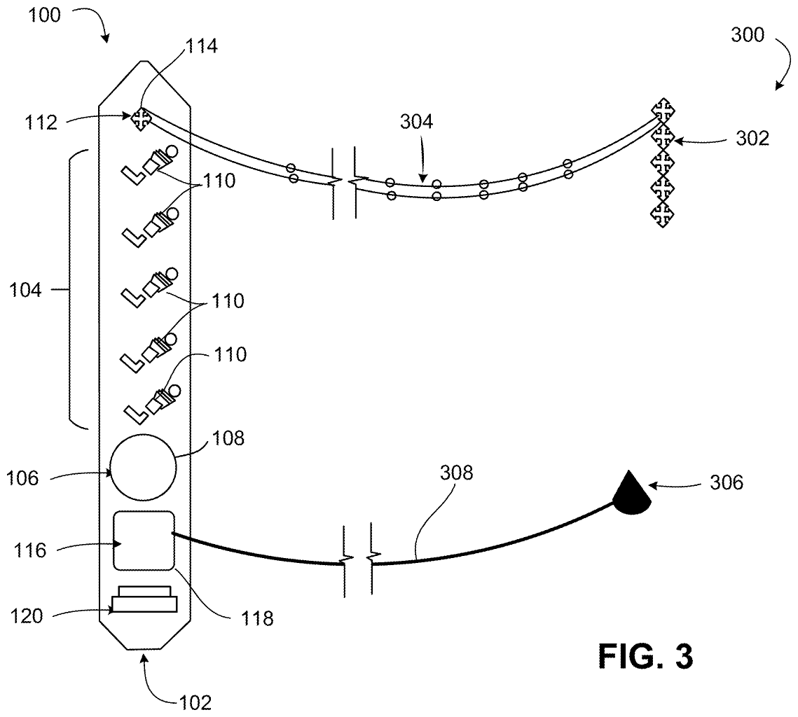

FIG. 3 is a schematic top view of a second example floating power generation system 300 including the first example floating power generation system 100 and marine vessel 102 of FIG. 1, where the marine vessel 102 is connected to an electrical infrastructure 302 and a water utility network 306 of a destination. In the second example floating power generation system 300 of FIG. 3, the energy transformation system 112 connects to the electrical infrastructure 302 over an electric cable system 304, and the water processing system 116 connects to the water utility network 306 over a water pipeline 308. The electric cable system 304 can connect to the energy transformation system 112 and transmit the produced electricity from the energy conversion system 104 to the electrical infrastructure 302, for example, to provide the electrical infrastructure 302 with all or a portion of the the produced electricity. The water pipeline 308 can transmit the produced freshwater in the water storage tank 118 to the water utility network 306, for example, to provide the water utility network 306 with all or a portion of the produced water.

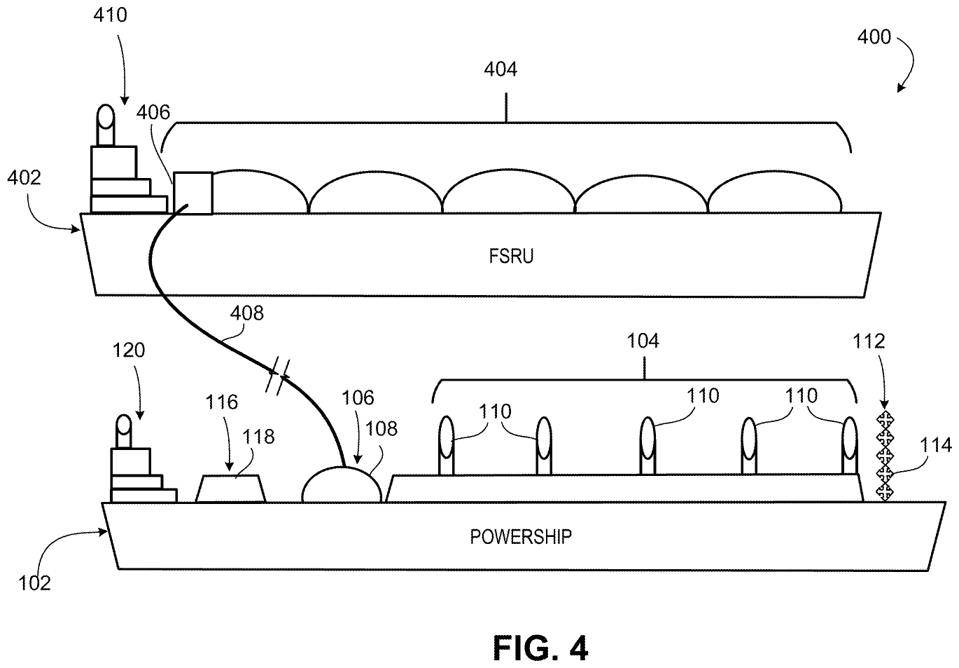

In some implementations, the marine vessel 102 of the example floating power generation system 100 receives fuel from a second, separate marine vessel. FIG. 4 is a schematic side view of a third example floating power generation system 400 that includes the marine vessel 102 of the example floating power generation system 100, and a second marine vessel 402. The second marine vessel 402 is a floating storage and regasification vessel and includes one or more fuel storage tanks 404 (five shown) for storing hydrogen in liquid form. The second marine vessel 402 also includes a regasification system 406 including a regasification unit mounted on the second marine vessel 402 and fluidly connected to the fuel storage tank 108 of the fuel storage system 106 on the marine vessel 102. The regasification system 406 can convert all or a portion of the liquid hydrogen from the fuel storage tank(s) 404 into gaseous hydrogen fuel and transmit the gaseous hydrogen fuel to the fuel storage tank 108 on the marine vessel 102. The second marine vessel 402 is sometimes referred to as a floating storage and regasification unit (FSRU), for example, since the second marine vessel 402 is equipped to convert stored liquid hydrogen to gaseous hydrogen, where the gaseous hydrogen can be transferred to the marine vessel 102 of the example floating power generation system 100. In the third example floating power generation system 400 of FIG. 4, a fluid pipeline 408 fluidly connects the regasification system 406 to the fuel storage system 106. The fluid pipeline 408 is a temporary, disconnectable, and flexible hose extending between and suspended between the marine vessel 102 and the second marine vessel 402. The fluid pipeline 408 allows for the transmission of gaseous hydrogen fuel from the second marine vessel 402 to the marine vessel 102, for example, to refill the fuel storage tank 108 of the fuel storage system 106 of the marine vessel 102. The second marine vessel 402 also includes its own propulsion system for independent movement controlled at a control module 410 of the second marine vessel 402. In some instances, the second marine vessel 402 is a cargo barge that excludes its own propulsion system. The second marine vessel 402 provides gaseous hydrogen fuel to the marine vessel 102 as needed to maintain a desired power output of the energy conversion system 104 on the marine vessel 102.

In some implementations, the regasification system 406 and the connected fuel storage tanks 404 is positioned on the second marine vessel 402 instead of the marine vessel 102 to reduce a footprint of the marine vessel 102. This reduced footprint provides a more mobile marine vessel 102, and the hydrogen fuel supply on the marine vessel 102 can be replenished by the second marine vessel 402 without moving or disconnecting the first marine vessel 102 from the electricity infrastructure at the destination. In addition, separating the energy conversion system 104 on the first vessel 102 from the fuel storage tanks 404 and regasification system 406 of the second vessel 402 onto different marine vessels allows for increased flexibility and maneuverability of vessels, for example, during emergency situations where the marine vessel 102 can be separated from the second marine vessel 402 to keep a safe distance and maneuver independently from each other. Further, the smaller footprint and reduced weight of the vessel provides for access to shallower waterways, as compared to a vessel that combines the storage tanks 404 and energy conversion system 104 onto a single marine vessel.

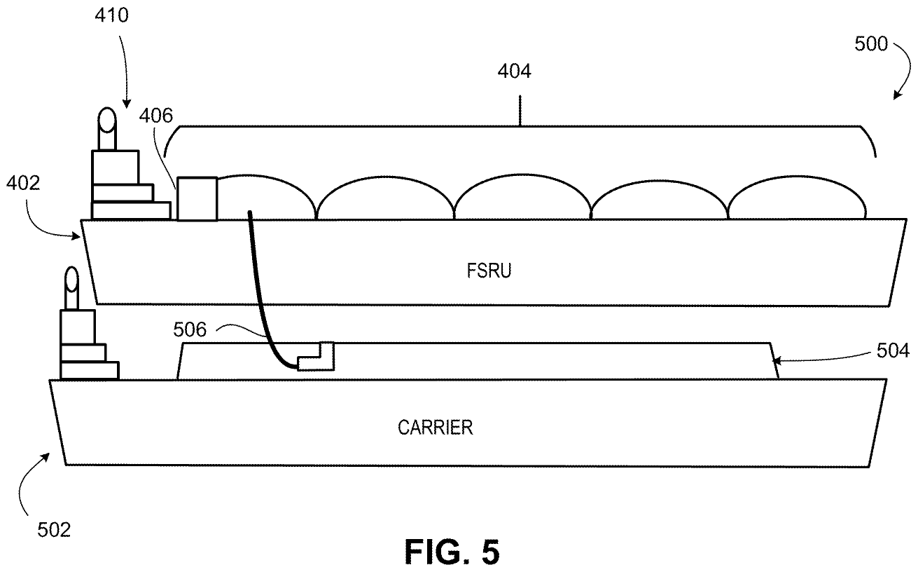

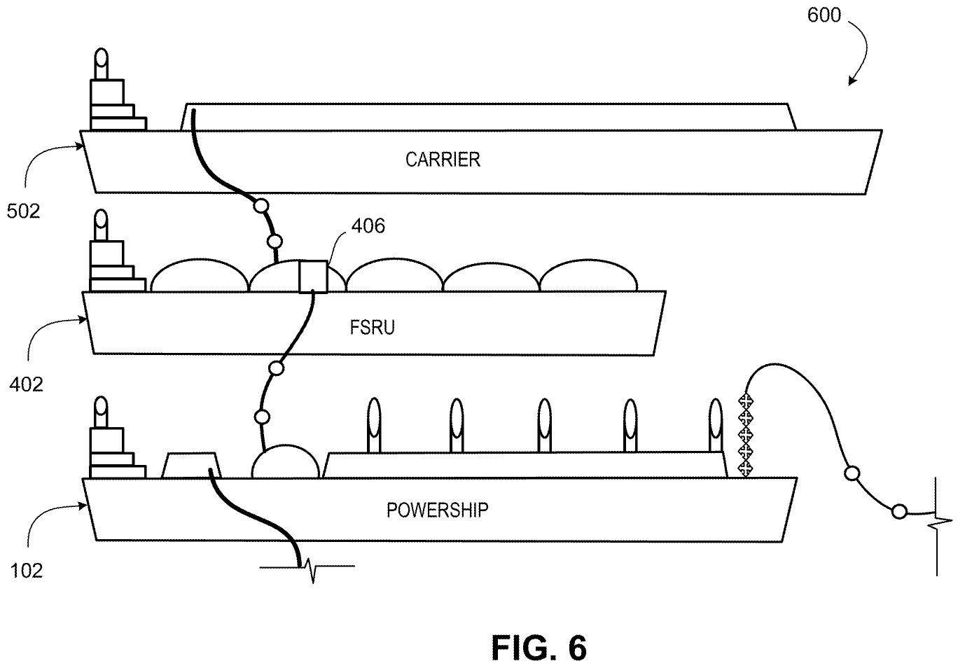

In some instances, such as during extended periods of power generation by the third example floating power generation system 400, the second marine vessel 402, or floating storage and regasification vessel, can receive liquid hydrogen from a supply vessel, from an onshore hydrogen source, or another liquid hydrogen source. FIG. 5 is a schematic side view of an example fuel supply system 500 that can be used in the third example floating power generation system 400 of FIG. 4, and FIG. 6 is a schematic side view of a fourth example floating power generation system 600 including the marine vessel 102 of FIG. 1 and the example fuel supply system 500 of FIG. 5. The example fuel supply system 500 includes the second marine vessel 402 of the third example floating power generation system 400 of FIG. 4, and includes a third marine vessel 502 including a liquid fuel storage tank 504 fluidly connected to the fuel storage tank 404 of the second marine vessel 402 with a floating pipeline 506. The third marine vessel 502 is a hydrogen carrying tanker ship storing liquid hydrogen fuel in its liquid fuel storage tank 504, and can connect to and pump liquid hydrogen to the fuel storage tank 404 of the second marine vessel 402. Liquid form hydrogen can be used for high-volume transport, since it is more cost-effective and volume-efficient to transport liquid hydrogen as compared to gaseous hydrogen over long transportation distances. Hydrogen gas is cooled down to a cryogenic temperature as part of the liquification process to generate liquid form of hydrogen, which includes cooling the hydrogen gas down to below −253 degrees Celsius (−423 degrees Fahrenheit) to convert to liquid form and be stored as liquid form. The liquid fuel storage tank 504 is insulated and pressurized to maintain the cryogenic temperature of the hydrogen gas during transportation.

In operation, the liquid hydrogen can be first transferred from the third marine vessel 502 to the second marine vessel 402 through the fluid pipeline 506. On the second marine vessel 402, the regasification system 406 converts the liquid hydrogen to gas form, which is then transferred to the marine vessel 102 through the pipeline 408. The pipeline 408 can include a coeflexif hose. A coeflexif hose is a high pressure hose, for example, with a pressure rating up to 10,000 pounds per square inch (psi). Flexible hoses provide advantages over hard piping systems. For example, a coeflexif hose provides flexible options for fluid connections between separate marine vessels, such as during harsh offshore conditions including heavy waves, wind, sea level changes, or other oceanic conditions, and can be equipped with an emergency release system for quick disconnection of the hose, such as in instances where two connected marine vessels move away from each other. In the pipeline 408 of the third example floating power generation system 400, a coeflexif hose is used that can handle hydrogen in a gaseous or liquid phase, and performs with a gas tight seal. One or more flexible hoses (such as a coeflexif hose) can be used for transferring hydrogen as gas or liquid, such as between third marine vessel 502 and second marine vessel 402, between second marine vessel 402 and marine vessel 102, between marine vessel 102 and third marine vessel 502, or a combination of these. In the example fuel supply system 500 of FIG. 5, the storage tanks 404 on the second marine vessel 402 can be continuously replenished by additional hydrogen carrying tankers ships (such as third marine vessel 502) to continuously provide hydrogen fuel to the energy conversion system 104 of the marine vessel 102 based on a desired power output or power demand.

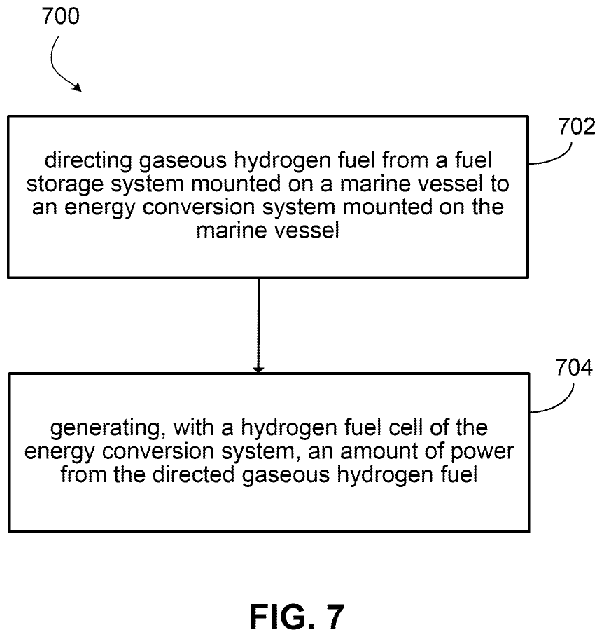

FIG. 7 is a flowchart describing an example method 700 for generating power on a marine vessel, for example, performed by the example floating power generation system 100 of FIGS. 1 and 2, the second example floating power generation system 300 of FIG. 3, the third example floating power generation system 400 of FIG. 4, or the fourth example floating power generation system 600 of FIG. 6. At 702, gaseous hydrogen fuel is directed from a fuel storage system mounted on a marine vessel to an energy conversion system mounted on the marine vessel. At 704, a hydrogen fuel cell of the energy conversion system generates an amount of power from the directed gaseous hydrogen fuel. In some instances, the generated amount of power from the energy conversion system is received at an energy transformation system mounted on the marine vessel, and the generated amount of power is directed over a cable system coupled to the energy transformation system. In certain instances, a water byproduct from the hydrogen fuel cell of the energy conversion system is received at a water processing system and stored in a water storage tank of the water processing system.

In some implementations, liquid hydrogen is received at a regasification system mounted on a second marine vessel from a fuel storage tank mounted on the second marine vessel, and the regasification system converts the liquid hydrogen into gaseous hydrogen fuel and flows the gaseous hydrogen fuel to the fuel storage system of the first marine vessel through a fluid pipeline. In certain implementations, a second fuel storage tank on a third marine vessel stores liquid hydrogen on the third marine vessel, and a second fluid pipeline flows at least a portion of the liquid hydrogen from the second fuel storage tank to the fuel storage tank of the second marine vessel.

While this disclosure contains many specific implementation details, these should not be construed as limitations on the scope of what may be claimed, but rather as descriptions of features specific to particular implementations. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described components and systems can generally be integrated together in a single product or packaged into multiple products.

Thus, particular implementations of the subject matter have been described. Other implementations are within the scope of the following claims. Various modifications may be made without departing from the spirit and scope of the disclosure. In some cases, the actions recited in the claims can be performed in a different order and still achieve desirable results. In addition, the processes depicted in the accompanying figures do not necessarily require the particular order shown, or sequential order, to achieve desirable results.

### EXAMPLES

In a first aspect, a floating power generation system comprises a marine vessel, an energy conversion system mounted on the marine vessel, the energy conversion system comprising a hydrogen fuel cell, and a fuel storage system mounted on the marine vessel and fluidly connected to the energy conversion system, the fuel storage system configured to supply hydrogen fuel to the hydrogen fuel cell of the energy conversion system.

In a second aspect according to the first aspect, the marine vessel is a powership comprising a command module communicably connected to the energy conversion system.

In a third aspect according to the first aspect or the second aspect, the floating power generation system further comprises an energy transformation system mounted on the marine vessel and connected to the energy conversion system, the energy transformation system configured to receive produced energy from the energy conversion system.

In a fourth aspect according to any one of the first aspect to the third aspect, the floating power generation system of further comprises a water processing system mounted on the marine vessel and fluidly connected to the hydrogen fuel cell of the energy conversion system, the water processing system configured to receive a water byproduct from the energy conversion system.

In a fifth aspect according to the fourth aspect, the water processing system comprises a water storage tank, the water storage tank configured to receive and store the water byproduct from the energy conversion system.

In a sixth aspect according to any one of the first aspect to the fifth aspect, the hydrogen fuel cell is a first hydrogen fuel cell, the energy conversion system comprises a plurality of hydrogen fuel cells, and the plurality of hydrogen fuel cells comprises the first hydrogen fuel cell.

In a seventh aspect according to any one of the first aspect to the sixth aspect, the hydrogen fuel cell comprises a proton exchange membrane fuel cell or solid oxide fuel cell.

In an eighth aspect according to any one of the first aspect to the seventh aspect, the marine vessel is a first marine vessel, and the floating power generation system further comprises: a second marine vessel separate from the first marine vessel, a fuel storage tank mounted on the second marine vessel, the fuel storage tank configured to store hydrogen in liquid form, a regasification system comprising a regasification unit mounted on the second marine vessel and fluidly connected to the fuel storage tank, the regasification system configured to convert liquid hydrogen from the fuel storage tank into gaseous hydrogen fuel, and a fluid pipeline fluidly connected to the regasification system and the fuel storage system, the fluid pipeline to transfer gaseous hydrogen fuel from the regasification system on the second marine vessel to the fuel storage system on the first marine vessel.

In a ninth aspect according to the eighth aspect, the fluid pipeline comprises a flexible hose extending between the regasification system and the fuel storage system.

In a tenth aspect according to the eighth aspect or the ninth aspect, the floating power generation system further comprises a third marine vessel, the third marine vessel comprising a carrier ship having a second fuel storage tank configured to store hydrogen in liquid form, and a second fluid pipeline fluidly connected to the second fuel storage tank of the third marine vessel and the fuel storage tank of the second marine vessel, the second fluid pipeline to transfer liquid hydrogen from the second fuel storage tank to the fuel storage tank of the second marine vessel.

In an eleventh aspect, a method for generating power on a marine vessel comprises directing gaseous hydrogen fuel from a fuel storage system mounted on a marine vessel to an energy conversion system mounted on the marine vessel, and generating, with a hydrogen fuel cell of the energy conversion system, an amount of power from the directed gaseous hydrogen fuel.

In a twelfth aspect according to the eleventh aspect, the method further comprises receiving, at an energy transformation system mounted on the marine vessel, the generated amount of power from the energy conversion system.

In a thirteenth aspect according to the twelfth aspect, the method further comprises directing, with the energy transformation system, the generated amount of power over a cable system coupled to the energy transformation system.

In a fourteenth aspect according to any one of the eleventh aspect to the thirteenth aspect, the method further comprises receiving, at a water processing system mounted on the marine vessel and fluidly connected to the energy conversion system, a water byproduct from the hydrogen fuel cell of the energy conversion system.

In a fifteenth aspect according to the fourteenth aspect, the method further comprises storing, at a water storage tank of the water processing system, the received water byproduct from the energy conversion system.

In a sixteenth aspect according to any one of the eleventh aspect to the fifteenth aspect, the hydrogen fuel cell is a first hydrogen fuel cell, the energy conversion system comprises a plurality of hydrogen fuel cells, and the plurality of hydrogen fuel cells comprises the first hydrogen fuel cell, and generating the amount of power comprises generating the amount of power with the plurality of hydrogen fuel cells.

In a seventeenth aspect according to any one of the eleventh aspect to the sixteenth aspect, the marine vessel is a first marine vessel, and the method further comprises: receiving, at a regasification system mounted on a second marine vessel, liquid hydrogen from a fuel storage tank mounted on the second marine vessel, converting, with a regasification unit of the regasification system, the liquid hydrogen into gaseous hydrogen fuel, the regasification unit mounted on the second marine vessel and fluidly connected to the fuel storage tank, and flowing, through a fluid pipeline fluidly connected to the regasification system and the fuel storage system, the converted gaseous hydrogen fuel from the regasification system on the second marine vessel to the fuel storage system on the first marine vessel.

In an eighteenth aspect according to the seventeenth aspect, the method further comprises storing, with a second fuel storage tank on a third marine vessel, liquid hydrogen on the third marine vessel, and flowing, through a second fluid pipeline fluidly connected to the second fuel storage tank and the fuel storage tank of the second marine vessel, at least a portion of the liquid hydrogen from the second fuel storage tank on the third marine vessel to the fuel storage tank on the second marine vessel.

In a nineteenth aspect, a power generating marine vessel comprises a marine vessel body comprising a deck, an energy conversion system mounted on the deck of the marine vessel body, the energy conversion system comprising a plurality of hydrogen fuel cells configured to generate an amount of electrical power from an amount of hydrogen fuel, and a fuel storage system mounted on the marine vessel and fluidly connected to the energy conversion system, the fuel storage system comprising a fuel tank storing the amount of hydrogen fuel, the fuel storage system configured to supply the amount of hydrogen fuel to the plurality of hydrogen fuel cells.

In a twentieth aspect according to the nineteenth aspect, the marine vessel is a powership or a power barge.

What is claimed is:

1. A floating power generation system, comprising:
a marine vessel;
an energy conversion system mounted on the marine vessel, the energy conversion system comprising a hydrogen fuel cell; and
a fuel storage system mounted on the marine vessel and fluidly connected to the energy conversion system, the fuel storage system configured to supply hydrogen fuel to the hydrogen fuel cell of the energy conversion system.

2. The floating power generation system of claim 1, wherein the marine vessel is a powership comprising a command module communicably connected to the energy conversion system.

3. The floating power generation system of claim 1, further comprising an energy transformation system mounted on the marine vessel and connected to the energy conversion system, the energy transformation system configured to receive produced energy from the energy conversion system.

4. The floating power generation system of claim 1, further comprising a water processing system mounted on the marine vessel and fluidly connected to the hydrogen fuel cell of the energy conversion system, the water processing system configured to receive a water byproduct from the energy conversion system.

5. The floating power generation system of claim 4, wherein the water processing system comprises a water storage tank, the water storage tank configured to receive and store the water byproduct from the energy conversion system.

6. The floating power generation system of claim 1, wherein the hydrogen fuel cell is a first hydrogen fuel cell, the energy conversion system comprises a plurality of hydrogen fuel cells, and the plurality of hydrogen fuel cells comprises the first hydrogen fuel cell.

7. The floating power generation system of claim 1, wherein the hydrogen fuel cell comprises a proton exchange membrane fuel cell or solid oxide fuel cell.

8. The floating power generation system of claim 1, wherein the marine vessel is a first marine vessel, and the floating power generation system further comprising:
a second marine vessel separate from the first marine vessel;
a fuel storage tank mounted on the second marine vessel, the fuel storage tank configured to store hydrogen in liquid form;
a regasification system comprising a regasification unit mounted on the second marine vessel and fluidly connected to the fuel storage tank, the regasification system configured to convert liquid hydrogen from the fuel storage tank into gaseous hydrogen fuel; and
a fluid pipeline fluidly connected to the regasification system and the fuel storage system, the fluid pipeline to transfer gaseous hydrogen fuel from the regasification system on the second marine vessel to the fuel storage system on the first marine vessel.

9. The floating power generation system of claim 8, wherein the fluid pipeline comprises a flexible hose extending between the regasification system and the fuel storage system.

10. The floating power generation system of claim 8, further comprising:
a third marine vessel, the third marine vessel comprising a carrier ship having a second fuel storage tank configured to store hydrogen in liquid form; and
a second fluid pipeline fluidly connected to the second fuel storage tank of the third marine vessel and the fuel storage tank of the second marine vessel, the second fluid pipeline to transfer liquid hydrogen from the second fuel storage tank to the fuel storage tank of the second marine vessel.

11. A method for generating power on a marine vessel, the method comprising:
directing gaseous hydrogen fuel from a fuel storage system mounted on a marine vessel to an energy conversion system mounted on the marine vessel; and
generating, with a hydrogen fuel cell of the energy conversion system, an amount of power from the directed gaseous hydrogen fuel.

12. The method of claim 11, further comprising receiving, at an energy transformation system mounted on the marine vessel, the generated amount of power from the energy conversion system.

13. The method of claim 12, further comprising directing, with the energy transformation system, the generated amount of power over a cable system coupled to the energy transformation system.

14. The method of claim 11, further comprising receiving, at a water processing system mounted on the marine vessel and fluidly connected to the energy conversion system, a water byproduct from the hydrogen fuel cell of the energy conversion system.

15. The method of claim 14, further comprising storing, at a water storage tank of the water processing system, the received water byproduct from the energy conversion system.

16. The method of claim 11, wherein the hydrogen fuel cell is a first hydrogen fuel cell, the energy conversion system comprises a plurality of hydrogen fuel cells, and the plurality of hydrogen fuel cells comprises the first hydrogen fuel cell, and
generating the amount of power comprises generating the amount of power with the plurality of hydrogen fuel cells.

17. The method of claim 11, wherein the marine vessel is a first marine vessel, and the method further comprises:
receiving, at a regasification system mounted on a second marine vessel, liquid hydrogen from a fuel storage tank mounted on the second marine vessel;
converting, with a regasification unit of the regasification system, the liquid hydrogen into gaseous hydrogen fuel, the regasification unit mounted on the second marine vessel and fluidly connected to the fuel storage tank; and
flowing, through a fluid pipeline fluidly connected to the regasification system and the fuel storage system, the converted gaseous hydrogen fuel from the regasification system on the second marine vessel to the fuel storage system on the first marine vessel.

18. The method of claim 17, further comprising:
storing, with a second fuel storage tank on a third marine vessel, liquid hydrogen on the third marine vessel; and
flowing, through a second fluid pipeline fluidly connected to the second fuel storage tank and the fuel storage tank of the second marine vessel, at least a portion of the liquid hydrogen from the second fuel storage tank on the third marine vessel to the fuel storage tank on the second marine vessel.

19. A power generating marine vessel, comprising:
a marine vessel body comprising a deck;
an energy conversion system mounted on the deck of the marine vessel body, the energy conversion system comprising a plurality of hydrogen fuel cells configured to generate an amount of electrical power from an amount of hydrogen fuel; and
a fuel storage system mounted on the deck of the marine vessel and fluidly connected to the energy conversion system, the fuel storage system comprising a fuel tank storing the amount of hydrogen fuel, the fuel storage system configured to supply the amount of hydrogen fuel to the plurality of hydrogen fuel cells.

20. The power generating marine vessel of claim 19, wherein the marine vessel is a powership or a power barge.
